(19) United States
(12) Patent Application Publication
(10) Pub. No.: US 2023/0169931 A1
(43) Pub. Date: Jun. 1, 2023

(54) DISPLAYS AND SYSTEM ON CHIP APPLIED TO DISPLAY

(71) Applicant: Realtek Semiconductor Corp., Hsinchu (TW)

(72) Inventors: Shi-Xuan Hong, HsinChu (TW); Li-Yu Chen, HsinChu (TW); Po-Hsien Wu, HsinChu (TW)

(73) Assignee: Realtek Semiconductor Corp., HsinChu (TW)

(21) Appl. No.: 17/964,026

(22) Filed: Oct. 11, 2022

(30) Foreign Application Priority Data
Nov. 29, 2021 (TW) 110144392

(51) Int. Cl. G09G 3/34; G09G 3/32

(52) U.S. Cl. CPC G09G 3/3406; G09G 3/32; G09G 2310/0291; G09G 2320/0626

(57) ABSTRACT

A display includes a system on chip (SoC), a plurality of driver integrated circuits (ICs), and a plurality of groups of light-emitting diodes (LEDs). The SoC is arranged to generate a plurality of backlight control signals according to an input image data. The plurality of driver ICs are coupled to the SoC, and arranged to receive the plurality of backlight control signals, respectively, to generate a plurality of driving signals. The plurality of groups of LEDs are coupled to the plurality of driver ICs, respectively, wherein the plurality of driving signals are arranged to control brightness of the plurality of groups of LEDs, respectively.

### BACKGROUND OF THE INVENTION

### 1. Field of the Invention

The present invention is related to backlight control of a display panel, and more particularly, to a method for reducing backlight delay and associated displays and a system on chip (SoC) applied to a display.

### 2. Description of the Prior Art

For the conventional liquid crystal display (LCD), local diming technology is applied in many products to improve image contrast. With the development of mini light-emitting diodes (mini LEDs), LCD panels are divided into more areas for regional light control (e.g. the number of areas may be more than 1,000). As a result, multiple driver integrated circuits (ICs) are needed to control the mini LEDs with multiple areas. However, in order to perform regional light control by the driver ICs, one or more relay ICs are needed to receive regional brightness information from the SoC, and generate and transmit a plurality of control signals to the driver ICs according to the regional brightness information. The transmission time of signals will be increased by setting one or more relay ICs, which increases the backlight delay.

### SUMMARY OF THE INVENTION

It is therefore one of the objectives of the present invention to provide a method for reducing backlight delay, to address the above-mentioned issues.

In an embodiment of the present invention, a display is provided. The display may include a system on chip (SoC), a plurality of driver integrated circuits (ICs), and a plurality of groups of light-emitting diodes (LEDs). The SoC may be arranged to generate a plurality of backlight control signals according to an input image data. The plurality of driver ICs may be coupled to the SoC, and may be arranged to receive the plurality of backlight control signals, respectively, to generate a plurality of driving signals. The plurality of groups of LEDs may be coupled to the plurality of driver ICs, respectively, wherein the plurality of driving signals are arranged to control brightness of the plurality of groups of LEDs, respectively.

In an embodiment of the present invention, an SoC applied to a display is provided. The SoC may include an image processing circuit, a backlight control circuit, and a plurality of output ports. The image processing circuit may be arranged to generate a processed input image data according to an input image data. The backlight control circuit may be arranged to generate a plurality of backlight control signals according to the input image data or the processed input image data, wherein each of the plurality of backlight control signals is arranged to control a group of LEDs of a display panel of the display. The plurality of output ports may be coupled to the backlight control circuit, and may be arranged to receive and output the plurality of backlight control signals, respectively.

In an embodiment of the present invention, a display is provided. The display may include an SoC, a microprocessor, a plurality of driver ICs, and a plurality of groups of LEDs. The SoC may be arranged to generate an initial backlight control signal according to an input image data. The microprocessor may be coupled to the SoC, and may be arranged to receive the initial backlight control signal, and perform signal splitting on the initial backlight control signal, to generate a plurality of backlight control signals. The plurality of driver ICs may be coupled to the SoC, and may be arranged to receive the plurality of the backlight control signals, respectively, to generate a plurality of driving signals. The plurality of groups of LEDs may be coupled to the plurality of driver ICs, respectively, wherein the plurality of driving signals are arranged to control brightness of the plurality of groups of LEDs, respectively. In addition, the input image data is an image data of a frame, and before the input image data is completely received, the SoC utilizes a single buffer transmission method to generate and output the initial backlight control signal according to contents of the input image data that have been received.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a display according to an embodiment of the present invention.

FIG. 2 is a timing diagram of an input image data, a plurality of backlight control signals, and a plurality of driving signals according to an embodiment of the present invention.

FIG. 3 is a timing diagram of an input image data, a plurality of backlight control signals, and a plurality of driving signals according to another embodiment of the present invention.

FIG. 4 is a timing diagram of an input image data, a plurality of backlight control signals, and a plurality of driving signals according to still another embodiment of the present invention.

FIG. 5 is a timing diagram of an input image data, a plurality of backlight control signals, and a plurality of driving signals according to still another embodiment of the present invention.

FIG. 6 is a diagram illustrating a display according to another embodiment of the present invention.

FIG. 7 is a timing diagram of an input image data, an initial backlight control signal, a plurality of backlight control signals, and a plurality of driving signals according to an embodiment of the present invention.

### DETAILED DESCRIPTION

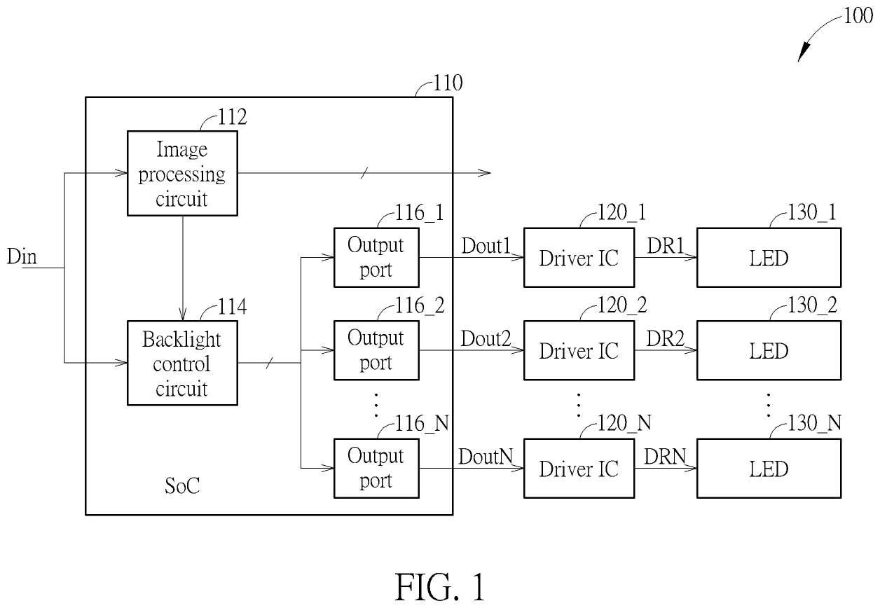

FIG. 1 is a diagram illustrating a display 100 according to an embodiment of the present invention. As shown in FIG. 1, the display 100 may include a system on chip (SoC) 110, a plurality of driver integrated circuits (ICs) 120_1-120_N, and a plurality of groups of light-emitting diodes (LEDs) 130_1-130_N, wherein the SOC 110 may include an image processing circuit 112, a backlight control circuit 114, and a plurality of output ports 116_1-116_N. In this embodiment, the display 100 is a liquid crystal display (LCD), and each LED in the groups of LEDs 130_1-130_N is a mini LED, but the present invention is not limited thereto.

When the display 100 is in operation, the SoC 110 may receive an input image data Din, the image processing circuit 112 may perform image processing on the input image data Din, to generate and transmit a processed input image data to a display panel for displaying, and the backlight control circuit 114 may generate a plurality of backlight control signals Dout1-DoutN according to the input image data Din and/or the processed input image data of the image processing circuit 112, and transmit the backlight control signals Dout1-DoutN to the driver ICs 120_1-120_N through the output ports 116_1-116_N. It should be noted that, since the design of the output ports and corresponding backlight control signals in the SoC 110 is the focus of this embodiment, and operations of the image processing circuit 112 are well known to those skilled in the art, the details of the image processing circuit 112 will not be described in the specification of the present invention. Afterwards, the driver ICs 120_1-120_N process the backlight control signals Dout1-DoutN, respectively, to generate and transmit a plurality of driving signals DR1-DRN to the groups of LEDs 130_1-130_N, for controlling brightness of each LED in the groups of LEDs 130_1-130_N.

In the embodiment shown in FIG. 1, each of the groups of LEDs 130_1-130_N is arranged to determine brightness of an area on a display panel of the display 100. A group of LEDs includes a plurality of LEDs, and a driver IC is arranged to control brightness of a group of LEDs. For example, it is assumed that the display 100 includes 4 groups of LEDs (i.e. Nis equal to 4), and each group of LEDs includes 500 LEDs. The backlight control circuit 114 may transmit the backlight control signal Dout1 with 500 brightness information to the driver IC 120_1 in series through the output port 116_1, thereby enabling the driver IC 120_1 to generate the driving signal DR1 with the 500 brightness information to control brightness of 500 LEDs in the first group of LEDs 130_1. At the same time, the backlight control circuit 114 may transmit the backlight control signal Dout2 with 500 brightness information to the driver IC 120_2 in series through the output port 116_2, thereby enabling the driver IC 120_2 to generate the driving signal DR2 with the 500 brightness information to control brightness of 500 LEDs in the second group of LEDs 130_2. The backlight control circuit 114 may transmit the backlight control signal Dout3 with 500 brightness information to the driver IC 120_3 in series through the output port 116_3, thereby enabling the driver IC 120_3 to generate the driving signal DR3 with the 500 brightness information to control brightness of 500 LEDs in the third group of LEDs 130_3. The backlight control circuit 114 may transmit the backlight control signal Dout4 with 500 brightness information to the driver IC 120_4 in series through the output port 116_4, thereby enabling the driver IC 120_4 to generate the driving signal DR4 with the 500 brightness information to control brightness of 500 LEDs in the fourth group of LEDs 130_4.

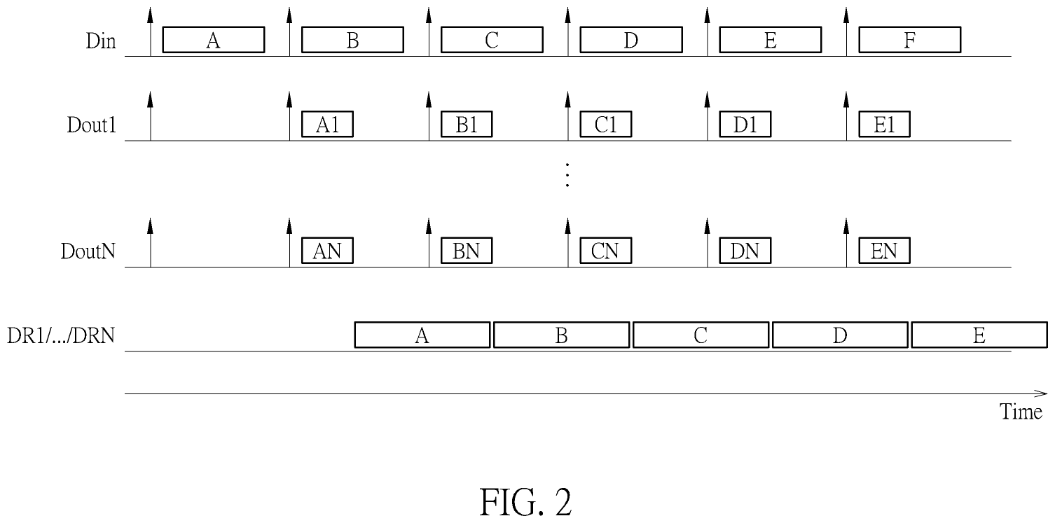

FIG. 2 is a timing diagram of an input image data Din, a plurality of backlight control signals Dout1-DoutN, and a plurality of driving signals DR1-DRN according to an embodiment of the present invention. As shown in FIG. 2, the input image data Din includes a plurality of image data of different frames (labeled as “A-F”, respectively) in sequence. After the image data of each frame in the input image data Din is received, the backlight control circuit 114 may simultaneously transmit the backlight control signals Dout1-DoutN to the driver ICs 120_1-120_N for generating the driving signals DR1-DRN, wherein A1-AN shown in FIG. 2 represent backlight control signals Dout1-DoutN of frame A, respectively, B1-BN represent backlight control signals Dout1-DoutN of frame B, respectively, and so on. It should be noted that, in FIG. 2 and the following figures, the arrows, each between two frames, are arranged to represent vertical synchronization signals (for brevity, labeled as “Vsync”).

In the embodiments shown in FIG. 1 and FIG. 2, since the SoC 110 sets up the output ports 116_1-116_N to transmit the backlight control signals Dout1-DoutN to the driver ICs 120_1-120_N, respectively, there is no need to set up any relay ICs between the SoC 110 and the driver ICs 120_1-120_N. For example, there is no need to set up a microprocessor between the SoC 110 and the driver ICs 120_1-120_N to split a backlight control signal into multiple backlight control signals. As a result, in addition to reducing manufacturing costs, it may also effectively reduce the signal transmission time for backlight delay reduction.

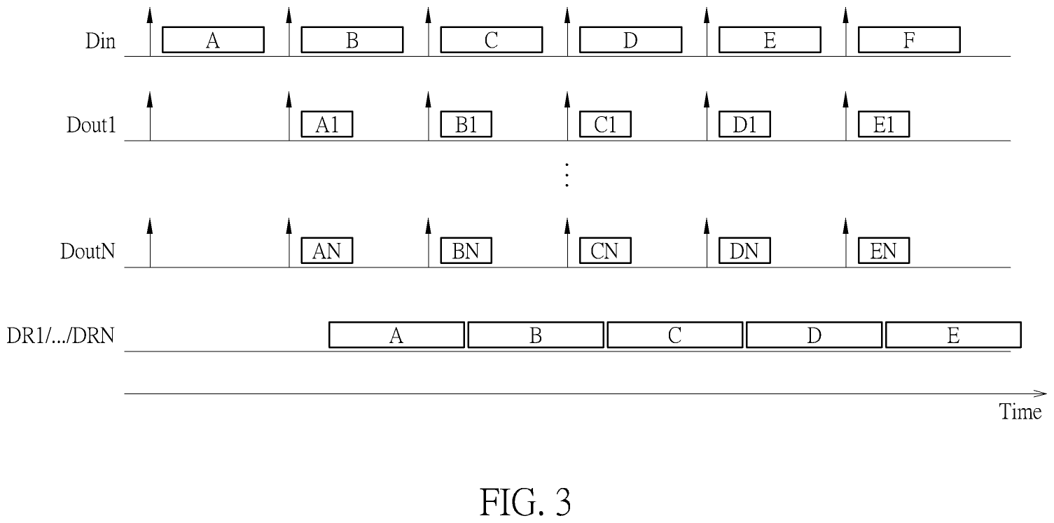

In an embodiment, in order to reduce manufacturing costs more effectively, before the complete backlight control signals have been received, the driver ICs 120_1-120_N may utilize a single-buffer transmission method to generate the driving signals DR1-DRN in sequence according to contents of the backlight control signals that have been received. Take FIG. 3 as an example for illustration, A1-AN shown in FIG. 3 may represent the backlight control signals Dout1-DoutN of the frame A. Before the driver ICs 120_1-120_N have received all of the A1-AN, the driver ICs 120_1-120_N have already generated the driving signals DR1-DRN corresponding to the frame A. B1-BN shown in FIG. 3 may represent the backlight control signals Dout1-DoutN of the frame B. Before the driver ICs 120_1-120_N have received all of the B1-BN, the driver ICs 120_1-120_N have already generated the driving signals DR1-DRN corresponding to the frame B. For brevity, similar descriptions for C1-CN, D1-DN, and E1-EN are not repeated in detail here. As a result, as shown in FIG. 3, the time delay of the image data Din and the corresponding driving signals DR1-DRN may be shorter, and the backlight delay may be further reduced.

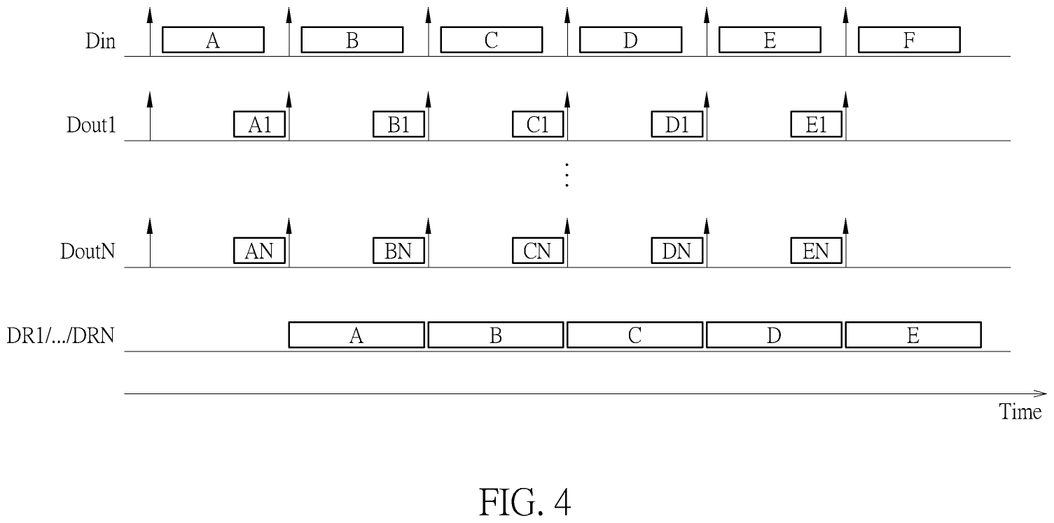

In another embodiment, in order to reduce the signal transmission time more effectively, before the complete input image data Din has been received, the backlight control circuit 114 may utilize the single buffer transmission method to generate the backlight control signals Dout1-DoutN in sequence according to contents of the input image data Din that have been received. Take FIG. 4 as an example for illustration, before the driver ICs 120_1-120_N have received complete contents of the frame A, the backlight control circuit 114 has already started to output the backlight control signals Dout1-DoutN of the frame A (labeled as “A1-AN”, respectively). Before the driver ICs 120_1-120_N have received complete contents of the frame B, the backlight control circuit 114 has already started to output the backlight control signals Dout1-DoutN of the frame B (labeled as “B1-BN”, respectively). For brevity, similar descriptions for C1-CN, D1-DN, and E1-EN are not repeated in detail here. As a result, as shown in FIG. 4, the time delay of the input image data Din and the corresponding driving signals DR1-DRN may be shorter, and the backlight delay may be further reduced.

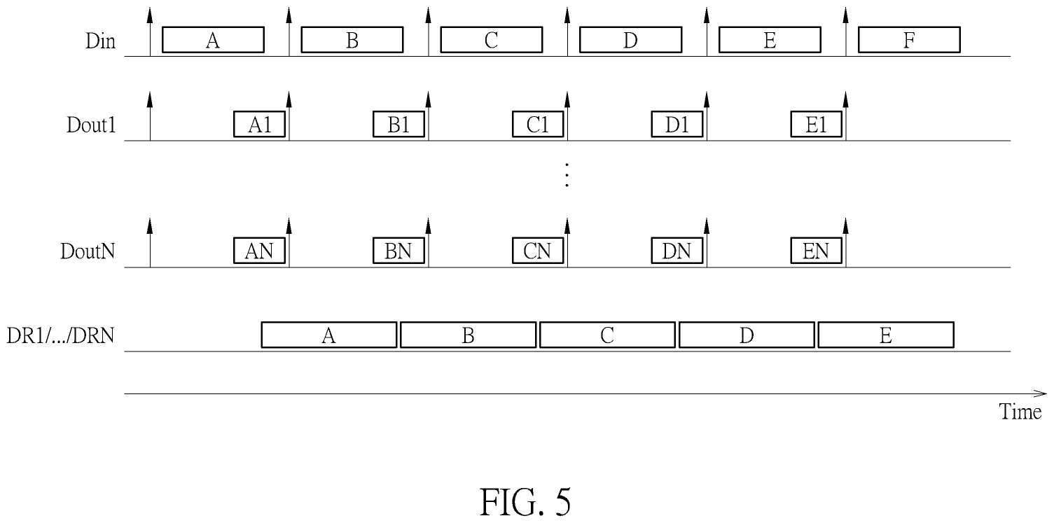

In another embodiment, in order to reduce the signal transmission time more effectively, before the complete input image data Din has been received, the backlight control circuit 114 may utilize the single-buffer transmission method to generate the backlight control signals Dout1-DoutN in sequence according to contents of the input image data Din that have been received. Before the complete backlight control signals have been received, the driver ICs 120_1-120_N may also utilize the single-buffer transmission method to generate the driving signals DR1-DRN in sequence according to contents of the backlight control signals that have been received. Take FIG. 5 as an example for illustration, before the driver ICs 120_1-120_N have received complete contents of the frame A, the backlight control circuit 114 has already started to output the backlight control signals Dou1-DoutN of the frame A (labeled as “A1-AN”, respectively). Before the driver ICs 120_1-120_N have received all of A1-AN, the driver ICs 120_1-120_N have already generated the driving signals DR1-DRN corresponding to the frame A. Before the driver ICs 120_1-120_N have received complete contents of the frame B, the backlight control circuit 114 has already started to output the backlight control signals Dou1-DoutN of the frame B (labeled as “B1-BN”, respectively). Before the driver ICs 120_1-120_N have received all of B1-BN, the driver ICs 120_1-120_N have already generated the driving signals DR1-DRN corresponding to the frame B. For brevity, similar descriptions for C1-CN, D1-DN, and E1-EN are not repeated in detail here. As a result, as shown in FIG. 5, the time delay of the input image data Din and the corresponding driving signals DR1-DRN may be shorter, and the backlight delay may be further reduced.

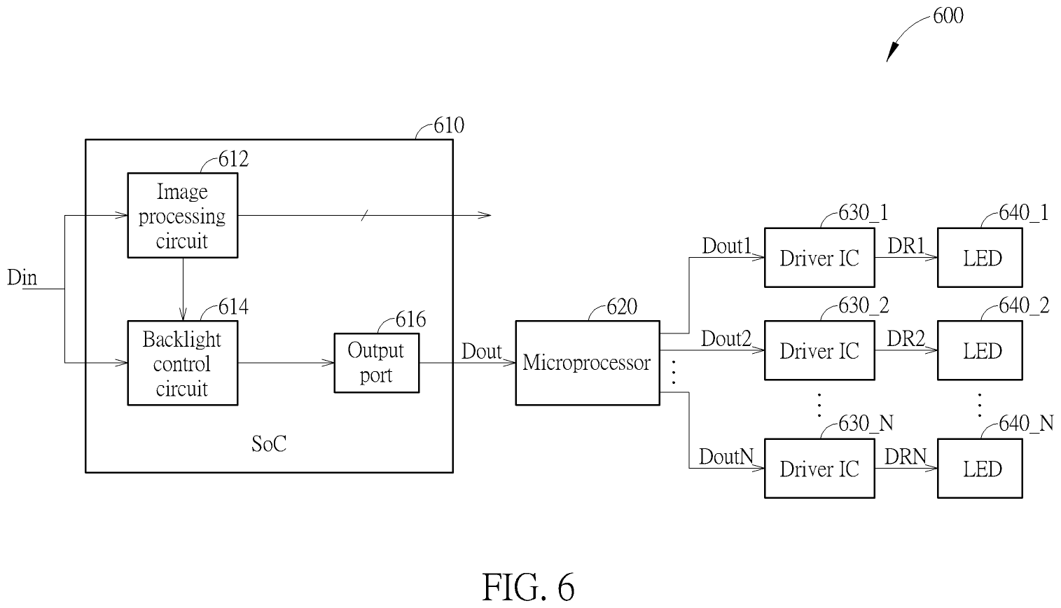

FIG. 6 is a diagram illustrating a display 600 according to an embodiment of the present invention. As shown in FIG. 6, the display 600 may include an SoC 610, a microprocessor 620, a plurality of driver ICs 630_1-630_N, and a plurality of groups of LEDs 640_1-640_N, wherein the SoC 610 may include an image processing circuit 612, a backlight control circuit 614, and an output port 616. In this embodiment, the display 600 is an LCD, and each LED in the groups of LEDs 640_1-640_N is a mini LED, but the present invention is not limited thereto.

In the embodiment shown in FIG. 6, each LED in the groups of LEDs 640_1-640_N is arranged to determine brightness of an area on a display panel of the display 600. A group of LEDs includes a plurality of LEDs, and a driver IC is arranged to control brightness of a group of LEDs. For example, the display 600 may include 4 groups of LEDs (i.e. N is equal to 4), and each group of LEDs may include 500 LEDs.

When the display 600 is in operation, the SoC 610 may receive an input image data Din, and the image processing circuit 612 may perform image processing on the input image data Din, to generate and output a processed image data to the display panel for displaying. The backlight control circuit 614 may generate an initial backlight control signal Dout according to the input image data Din and/or the processed image data of the image processing circuit 612, and transmit the initial backlight control signal Dout to the microprocessor 620 through the output port 616. Afterwards, the microprocessor 620 may perform signal splitting on the initial backlight control signal Dout, to generate a plurality of backlight control signals Dout1-DoutN. The driver ICs 630_1-630_N may process the backlight control signals Dout1-DoutN, respectively, to generate and output a plurality of driving signals DR1-DRN to the groups of LEDs 640_1-640_N, for controlling brightness of each LED in the groups of LEDs 640_1-640_N.

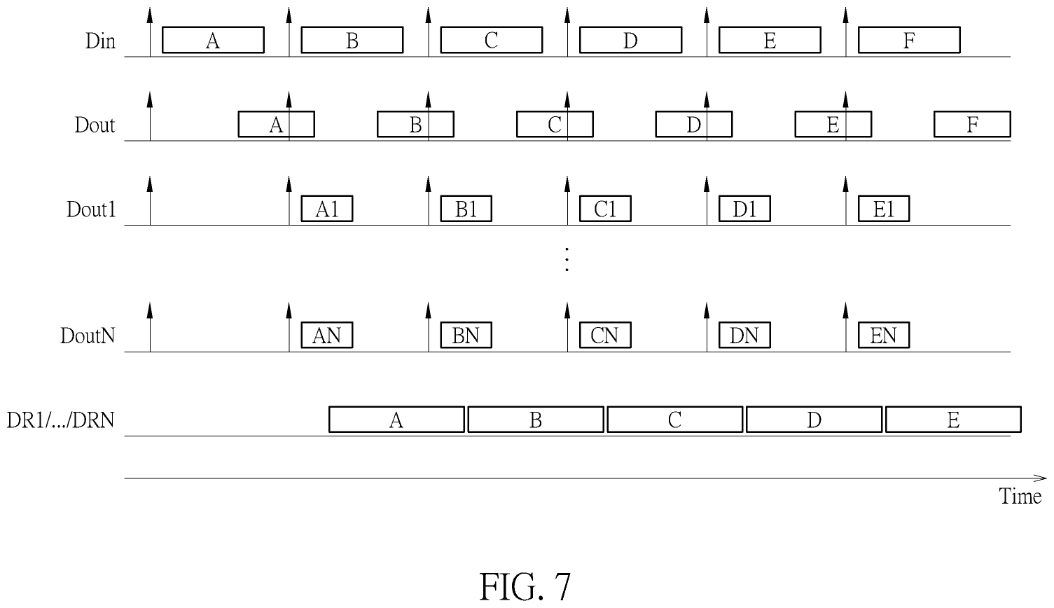

FIG. 7 is a timing diagram of an input image data Din, an initial backlight control signal Dout, a plurality of backlight control signals Dout1-DoutN, and a plurality of driving signals DR1-DRN. As shown in FIG. 7, before the complete input image data Din has been received, the backlight control circuit 614 may utilize the single-buffer transmission method to generate the initial backlight control signal Dout in sequence according to contents of the input image data Din that have been received. Before the complete initial backlight control signal Dout has been received, the microprocessor 620 may also utilize the single-buffer transmission method to generate the backlight control signals Dout1-DoutN in sequence according to contents of the initial backlight control signal Dout that have been received. Before the complete backlight control signals have been received, the driver ICs 630_1-630_N may also utilize the single-buffer transmission method to generate the driving signals DR1-DRN in sequence according to contents of the backlight control signals that have been received. Take FIG. 7 as an example for illustration, before the driver ICs 630_1-630_N have received complete contents of the frame A, the backlight control circuit 614 has already output the initial backlight control signal Dout of the frame A. Before the complete initial backlight control signal Dout that corresponds to the frame A has been received, the microprocessor 620 generates the backlight control signals Dout1-DoutN of the frame A (labeled as “A1-AN”, respectively) in sequence according to contents of the initial backlight control signal Dout that have been received. Before the driver ICs 630_1-630_N have received all of A1-AN, the driver ICs 630-1-630_N have already generated the driving signals DR1-DRN corresponding to the frame A. For brevity, similar descriptions for frames B-E are not repeated in detail here. As a result, as shown in FIG. 7, the time delay of the input image data Din and the corresponding driving signals DR1-DRN may be shorten, and the backlight delay may be reduced.

In summary, in the display of the present invention, by directly setting the output ports in the SoC to directly output the backlight control signals to the driver ICs, the cost of the relay ICs may be saved, and the time delay between the input image data and the corresponding driving signals may be shorten. In addition, by utilizing the single-buffer transmission method between chips for data transmission, the backlight delay may be further reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display, comprising:
a system on chip (SoC), arranged to generate a plurality of backlight control signals according to an input image data;
a plurality of driver integrated circuits (ICs), coupled to the SoC, and arranged to receive the plurality of backlight control signals, respectively, to generate a plurality of driving signals; and
a plurality of groups of light-emitting diodes (LEDs), coupled to the plurality of driver ICs, respectively, wherein the plurality of driving signals are arranged to control brightness of the plurality of groups of LEDs, respectively.

2. The display of claim 1, wherein the SoC comprises:
an image processing circuit, arranged to generate a processed input image data according to the input image data;
a backlight control circuit, arranged to generate the plurality of backlight control signals according to the input image data or the processed input image data; and
a plurality of output ports, coupled to the backlight control circuit, and arranged to receive and output the plurality of backlight control signals, respectively.

3. The display of claim 1, wherein the SoC directly transmits the plurality of backlight control signals to the plurality of driver ICs, respectively, and there are no relay ICs between the SoC and the plurality of driver ICs.

4. The display of claim 1, wherein the input image data is an image data of a frame, and before the input image data is completely received, the SoC utilizes a single-buffer transmission method to generate and output the plurality of backlight control signals according to contents of the input image data that have been received.

5. The display of claim 1, wherein the plurality of backlight control signals are backlight control signals of a frame, and before the plurality of backlight control signals are completely received, the plurality of driver ICs utilize a single-buffer transmission method to generate the plurality of driving signals according to contents of the plurality of backlight control signals that have been received, respectively.

6. The display of claim 1, wherein the input image data is an image data of a frame, and before the input image data is completely received, the SoC utilizes a single-buffer transmission method to generate the plurality of backlight control signals according to contents of the input image data that have been received; and before the plurality of backlight control signals are completely received, the plurality of deriver ICs utilize the single-buffer transmission method to generate the plurality of driving signals according to contents of the plurality of backlight control signals that have been received, respectively.

7. A system on chip (SoC) applied to a display, comprising:
an image processing circuit, arranged to generate a processed input image data according to an input image data;
a backlight control circuit, arranged to generate a plurality of backlight control signals according to the input image data or the processed input image data, wherein each of the plurality of backlight control signals is arranged to control a group of light-emitting diodes (LEDs) of a display panel of the display; and
a plurality of output ports, coupled to the backlight control circuit, and arranged to receive and output the plurality of backlight control signals, respectively.

8. The SoC of claim 7, wherein the input image data is an image data of a frame, and before the input image data or the processed input image data is completely received, the backlight control circuit utilizes a single-buffer transmission method to generate and output the plurality of backlight control signals according to contents of the input image data or the processed input image data that have been received.

9. A display, comprising:
a system on chip (SoC), arranged to generate an initial backlight control signal according to an input image data;
a microprocessor, coupled to the SoC, and arranged to receive the initial backlight control signal, and perform signal splitting on the initial backlight control signal, to generate a plurality of backlight control signals;
a plurality of driver integrated circuits (ICs), coupled to the microprocessor, and arranged to receive the plurality of the backlight control signals, respectively, to generate a plurality of driving signals; and
a plurality of groups of light-emitting diodes (LEDs), coupled to the plurality of driver ICs, respectively, wherein the plurality of driving signals are arranged to control brightness of the plurality of groups of LEDs, respectively;
wherein the input image data is an image data of a frame, and before the input image data is completely received, the SoC utilizes a single-buffer transmission method to generate and output the initial backlight control signal according to contents of the input image data that have been received.

10. The display of claim 9, wherein before the plurality of backlight control signals are completely received, the plurality of driver ICs utilize the single-buffer transmission method to generate the plurality of driving signals according to contents of the plurality of backlight control signals that have been received, respectively.

11. The display of claim 9, wherein before the initial backlight control signal is completely received, the microprocessor utilizes the single-buffer transmission method to generate and output the plurality of backlight control signals according to contents of the initial backlight control signal that have been received.
